(19) United States
(12) Patent Application Publication
(10) Pub. No.: US 2020/0123074 A1
(43) Pub. Date: Apr. 23, 2020

(54) METHOD FOR PRODUCING A FERTILIZER PRODUCT

(71) Applicant: LYSTEK INTERNATIONAL CORPORATION, Cambridge (CA)

(72) Inventor: Owen Patrick Ward, Waterloo (CA)

(73) Assignee: LYSTEK INTERNATIONAL CORPORATION, Cambridge (CA)

(21) Appl. No.: 16/654,121

(22) Filed: Oct. 16, 2019

(30) Foreign Application Priority Data
Oct. 18, 2018 (GB) 1817017.5

(51) Int. Cl. C05F 7/00

(52) U.S. Cl. CPC C05F 7/00

(57) ABSTRACT

A method of forming a fertilizer product having a preselected viscosity. The method includes forming a mixture including a biosolids cake having biosolids defining a biosolids content thereof, and alkali in a predetermined amount based on the biosolids content of the biosolids cake. Sufficient process liquid is included in the mixture to result in the fertilizer product having a product biosolids content of up to approximately 16% by weight of the fertilizer product. With a mixing element, the mixture is mixed for a predetermined time period. The mixing element rotates at a predetermined tip speed during the predetermined time period, to produce the fertilizer product.

### FIELD OF THE INVENTION

The present invention is a method of forming a fertilizer product having a preselected viscosity.

### BACKGROUND OF THE INVENTION

As is well known in the art, raw sewage is treated both to remove contaminants such as pathogens and various other organic materials and to retrieve water from the wastewater influent streams presented to a municipal wastewater treatment plant. Initially, the raw sewage may include, e.g., between approximately 95% to 97% by weight water, and 3% to 5% by weight biosolids. The conventional processing of raw sewage takes place in treatment plants (often with multiple process steps that may or may not include anaerobic digestion), and then a large proportion of the water is typically removed from the waste stream for recycling/reprocessing in the water side of the treatment plant. Substantial water is removed by processes such flocculation and settling to form sewage sludge, which is moist. Use of dewatering equipment such as filters and centrifuges produces a drier cake-like product conventionally referred to as biosolids cake.

As is also well known in the art, the raw sewage is processed as described above in order to achieve a number of objectives efficiently, including reducing the volume of waste material and liquid that is required to be disposed of, upon exiting the treatment plant. The biosolids cake may include between about 18% and about 26% biosolids by weight of the biosolids cake. The biosolids cake typically has gel-like characteristics. Because the biosolids cake tends to adhere to surfaces, the biosolids cake is difficult to work with.

The biosolids cake must be disposed of. A conventional option for disposal has been to send the biosolids cake to landfill. Another has been incineration. However, most developed countries are reducing, eliminating or banning these options because of negative environmental impacts and because these practices result in long term global depletion of soil nutrients.

The biosolids cake may be utilized as fertilizer. This is generally seen as far better than disposal in a landfill or disposal by incineration, because this approach has the advantage of using a waste material to provide benefits that otherwise would not be provided. However, at this time, the conventional methods of making biosolids cake into a form of fertilizer have a number of disadvantages.

The biosolids cake may be formed into pellets, and then dried. This has the disadvantage that it is a relatively expensive process, partially due to the energy consumption involved.

Alternatively, the biosolids cake may be made into a fertilizer mixture that includes a high proportion of liquids and small particles of the biosolids. The fertilizer mixture has a high proportion of liquids so that the fertilizer can easily be pumped, to facilitate handling. There are various known methods of doing this. However, the known methods of making the biosolids cake into a pumpable fertilizer mixture tend to involve a number of relatively expensive steps, and tend to require significant processing time and/or energy inputs.

Alkali, when added to biosolids during thermal treatment, raises the pH of the sludge and promotes hydrolysis reactions that break down the biological materials in the biosolids. It is understood generally that the higher the temperature and pH of the biosolids cake during thermal treatment, the greater the disruption of the biosolids cake, and also the greater the rate of disruption of the biosolids cake. Accordingly, in some methods, the pH of the biosolids cake is raised at various temperatures.

Thus, it is often generally understood that the lowest viscosity is procured when the biosolids cake is raised to the highest temperature and the highest pH.

In another known method, the biosolids cake may be subjected to mechanical shearing, i.e., in addition to raising the pH and increasing the temperature. Such shearing attacks the biosolids and changes their properties, to enhance pumpability, but requires significant energy input. One such method is disclosed, for instance, in U.S. Pat. No. 6,808,636.

Because the heating process takes time, relatively large vessels are required, in order to achieve a suitable throughput. As a result, for methods such as this method, the capital costs are significant, and operating costs are also significant, due to the thermal and energy inputs.

There are also a few specialized chemical treatments, including surfactants, urea and urea ammonium nitrate which reduce the viscosity/improve pumpability of dewatered biosolids preparations.

In general, reduction of the viscosity of organic materials relies on hydrolysis of the viscous polymeric substances in these materials including proteins, carbohydrates, nucleic acid-containing polymers and more complex polymers. Alkali promotes hydrolysis of the viscous polymeric substances in biosolids. Rates of hydrolysis increase with increasing temperature. A general rule of thumb is that reaction rates double with each 10 C rise in temperature. In addition, the extent of hydrolysis achieved in a particular thermal treatment increases as the duration of the treatment increases.

### SUMMARY OF THE INVENTION

For the foregoing reasons, there is a need for a method of forming a fertilizer product that mitigates or overcomes the disadvantages or defects of the prior art.

In its broad aspect, the invention provides a method of forming a fertilizer product having a preselected viscosity. The method includes forming a mixture, and the mixing the mixture, in the absence of additional heat energy. The mixture includes a biosolids cake with biosolids defining a biosolids content of the biosolids cake, and alkali in a predetermined amount based on the biosolids content of the biosolids cake. Sufficient process liquid is added to result in the fertilizer product having a product biosolids content up to approximately 16% by weight of the fertilizer product. With a mixing element, the mixture is mixed for a predetermined time period. The mixing element rotates at a predetermined tip speed during the predetermined time period, to produce the fertilizer product.

### DETAILED DESCRIPTION

The invention includes a method of forming a fertilizer product having a preselected viscosity. As will be described, among other advantages, the method does not require significant energy input to achieve the mixing needed, and in certain embodiments, does not require heat energy input. As a result, the method of the invention may be utilized to achieve relatively high throughput.

In one embodiment, the method preferably includes forming a mixture including a biosolids cake including biosolids defining a biosolids content of the biosolids cake, and alkali in a predetermined amount based on the biosolids content of the biosolids cake, as will also be described. It is also preferred that sufficient process liquid is added to the mixture to result in the fertilizer product ultimately having a product biosolids content up to approximately 16% by weight of the fertilizer product. With a mixing element, the mixture including the biosolids cake, the alkali, and the process liquid are mixed together for a predetermined time period. The mixing element rotates at a predetermined tip speed during the predetermined time period, to produce the fertilizer product.

It will be understood that the fertilizer product produced by the method of the invention is a mixture, which includes the process liquid and small particles in the process liquid. The small particles are primarily bacterial cells, about 1-3 microns in diameter. For the purposes hereof, the “fertilizer product” refers to the fertilizer product mixture resulting from the method of the invention, and the “mixture”, when used in relation to the method of the invention, refers to the collection of the components of the fertilizer product when they are positioned in the mixing vessel, and during mixing thereof by the mixing element.

Those skilled in the art would be aware that, in general, mixtures of liquids and solid particles having relatively high viscosity (e.g., viscosity of approximately 15,000 centipoise, or more) may be pumped, however, pumping such mixtures is relatively expensive. The pumps required are relatively expensive, and relatively costly to operate. Accordingly, the method of the invention herein preferably results in the fertilizer product having a relatively low viscosity, e.g., less then approximately 15,000 cP, as will be described. In one embodiment, as will also be described, the method of the invention preferably is performed in the absence of heat energy inputs, e.g., generally at room temperature. It will be understood that the pH of the fertilizer product of the invention is sufficient to eliminate pathogens and other micro-organisms.

Because it is intended to dispose of the biosolids cake, those skilled in the art would appreciate that it is desirable to have a relatively higher biosolids content in the fertilizer product, to the extent feasible. However, those skilled in the art would also appreciate that increasing the biosolids content in the fertilizer product will, if the biosolids content is sufficiently high, tend to result in a more viscous fertilizer product, which is undesirable once the viscosity is greater than approximately 15,000 centipoise.

Those skilled in the art would also appreciate that there are additional aspects to consider in any particular context when determining how to form the fertilizer product, e.g., a desired throughput, and/or energy inputs. In different contexts, the optimum design may vary significantly due to, e.g., differences in the costs of the energy inputs.

As noted above, in the prior art, various methods for forming fertilizer mixtures from biosolids cake are known, however, they typically involve heating over a relatively long process time period, and may also require other energy inputs. In contrast, the method of the invention is surprising and counter-intuitive in view of the prior art, because the method of the invention lacks the advantages of promoting hydrolysis over a relatively long process time, and of promoting hydrolysis by adding heat. Surprisingly, and unexpectedly, in the method of the present invention, the low temperature and relatively short duration of the reaction conditions are sufficient to produce an easily pumpable fertilizer product.

In addition, the method of the invention preferably is effected without shearing the biosolids in the biosolids cake, when the mixture is mixed. This means that the mixing device in which the mixing element is mounted (i.e., to rotate the mixing element) requires less energy input than would have been needed if the biosolids in the biosolids cake were required to be subjected to shearing.

Preferably, the biosolids cake has a biosolids content that is between approximately 18% and approximately 26% by weight of the biosolids cake.

The alkali may be provided in any suitable form, and in any suitable amount. For instance, the alkali may be provided in the form of Cal85™, which includes approximately 85% CaO by weight. In one embodiment, and as will be described further below, the predetermined amount of the alkali preferably is at least about 75 kg CaO per 1,000 kilograms of the biosolids in the biosolids cake. It is also preferred that the predetermined amount of the alkali is up to about 150 kg CaO per 1,000 kilograms of the biosolids in the biosolids cake.

The alkali may be one or more of finely granulated lime, hydrated solid lime, slaked lime, finely granulated solid sodium hydroxide, finely granulated solid potassium hydroxide, liquid sodium hydroxide, liquid potassium hydroxide, and any suitable combinations thereof.

The predetermined tip speed may be any suitable tip speed, preferably a relatively low tip speed. In one embodiment, the predetermined tip speed preferably is less than approximately 1,000 feet per minute. Preferably, the predetermined tip speed is between approximately 250 feet per minute and approximately 1,000 feet per minute.

As will be described below, it is preferred that the biosolids cake, the alkali, and the process liquid are mixed together without shearing microbial cells in the biosolids of the biosolids cake. Surprisingly, it appears that the method of the invention is advantageously practised in the absence of shearing.

One of the goals that the method of the invention is intended to achieve is to provide a fertilizer mixture with a suitable low viscosity with relatively low energy inputs. In one embodiment, the mixing of the biosolids cake, the alkali, and the process liquid is effected with an energy input of between 0.05 kWh and 0.5 kWh, per 1,000 kilograms of the fertilizer product produced.

Similarly, the preselected viscosity may be any suitable viscosity, preferably a relatively low viscosity. It is preferred that the preselected viscosity is less than approximately 15,000 centipoise. In one embodiment, the preselected viscosity preferably is approximately 6,000 centipoise or less.

As described above, in order to form the fertilizer product of the invention, the process liquid is added to the other components of the mixture, prior to or during their mixing by the mixing element. The process liquid may be any suitable liquid, or any suitable dilute mixture of liquid(s) and solid(s). In one embodiment, the process liquid preferably is water. Alternatively, the process liquid preferably is a dilute liquid biosolids feed. In a further alternative embodiment, the process liquid may include water mixed with the dilute liquid biosolids feed, in any suitable proportions.

In one embodiment, the fertilizer product of the invention preferably includes at least 14% biosolids by weight of the mixture. The biosolids cake may be at least partially prepared from anaerobically digested biosolids.

One of the advantages of the method of the invention is the relatively short mixing time, which can result in overall greater throughput. In one embodiment, the predetermined time period preferably is between approximately 5 seconds and approximately 60 seconds.

The method of the invention also may include a step of storing the fertilizer product for a preselected time period. As will be described, this may be advantageous because further hydrolysis may take place during the preselected time period. In one embodiment, the preselected time period preferably is between approximately one day and approximately 75 days.

In another alternative embodiment, the method of the invention preferably additionally includes the step of heating the fertilizer product to a preselected temperature for a preselected heating time period to kill Helminth ova in the fertilizer product to a preselected extent.

The present invention is illustrated in the following experiments.

### Experiment 1

Different amounts of dewatered (anaerobically digested) biosolids cake (including 23% biosolids, by weight), and calcium oxide in the form of Cal85™, and water, were added to 500 mL containers and mixed for two minutes with a hand-held single ribbon mixer (i.e., subjected to non-violent mixing without shearing), without added heat. The resulting fertilizer products have 8.70-15.90% biosolids content. Cal85™ dose rates for each solids level were 26.8 kg/metric ton biosolids cake, 33.6 kg/metric ton of biosolids cake, and 40.4 kg/metric ton of biosolids cake. Viscosities and pHs of each mixture prepared, after production and over a 75-day period, are presented in Table 1.

The fertilizer product having 13.37% biosolids, prepared with 33.6 kg of Cal85™/metric ton of biosolids cake, exhibited stable viscosities of around 4,000 cP over the 75-day storage period. Product shelf life is satisfactory with pH dropping from 11.9 to 10.5 in the 75 days.

The same biosolids concentration, when treated with 40.4 kg of Cal85/metric ton of biosolids cake, resulted in a fertilizer product that exhibited stable and lower viscosities around 3,000 cP, with pH dropping from 12.3 to 11.3 over the 75 days.

A product containing 15.23% biosolids, which had been treated with 40.4 kg of Cal85™/metric ton of biosolids cake, exhibited a high viscosity of 116,000 cP after initial processing. However, the viscosity of the fertilizer product dropped to under 10,000 cP in the first week of storage and to less than 6,000 cP after 75 days of storage.

TABLE 1
High Throughput/Cold Process for Production of Pumpable Biosolids Liquid
Effect of Cal85 dose rate and solids concentration on product viscosity and pH

| | | | Product Solids | | | | | | | | | |
|---|---|---|---|---|---|---|---|---|---|---|---|---|
| | | | Content % | | Viscosities (0-75 days) | | | | pH (0-75 days) | | | |
| Ingredients* | | | by weight | | Storage Temp (~20 C.) | | | | Storage Temp (~20 C.) | | | |
| Cake 23% | H2O | Cal85 | Total | Biosolids | 0 d | 7 d | 30 d | 75 d | 0 d | 7 d | 30 d | 75 d |
| 200 g | 102 g | 5.36 g | 17.5 | 15.90 | 210K | 82K | 90K | 90K | | 10.7 | 10.4 | 10.2 |
| | 142 g | (26.8 Kg/MT | 15 | 13.67 | 8778 | 11.8K | 18K | 9718 | 11 | 10.3 | 10.1 | 9.4 |
| | 211 g | Cake) | 12.5 | 11.39 | 1356 | 2567 | 2430 | 2723 | 11 | 10.5 | 10.3 | 9.9 |
| | 314 g | | 10 | 9.11 | 444 | 846 | 1014 | 1104 | 11 | 10.3 | 9.9 | 9.6 |
| | 112 g | 6.72 g | 17.5 | 15.58 | 179K | 29K | 40K | 19.6K | 11.9 | 10.9 | 10.6 | 10.3 |
| | 148 g | (33.6 Kg/MT | 15 | 13.37 | 3461 | 4073 | 3947 | 3629 | 11.9 | 11.2 | 10.8 | 10.5 |
| | 218 g | Cake) | 12.5 | 11.14 | 972 | 1524 | 1572 | 1512 | 11.9 | 11.1 | 10.8 | 10.6 |
| | 322 g | | 10 | 8.91 | 270 | 378 | 378 | 402 | 11.9 | 11.4 | 11.0 | 10.8 |
| | 120 g | 8.8 g | 17.5 | 15.23 | 116K | 9900 | 8478 | 5207 | 12.3 | 11.9 | 11.6 | 11.3 |
| | 153 g | (40.4 Kg/MT | 15 | 13.05 | 2807 | 3005 | 2447 | 2345 | 12.3 | 11.9 | 11.6 | 11.3 |
| | 224 g | Cake) | 12.5 | 10.88 | 654 | 852 | 792 | 714 | 12.3 | 11.9 | 11.8 | 11.5 |
| | 330 g | | 10 | 8.70 | 294 | 342 | 294 | 240 | 12.3 | 11.9 | 11.9 | 11.6 |

*Added to 500 mL container and mixed for 2 minutes with BD mixer

As noted above, it is preferred that the fertilizer product of the invention has a viscosity less than approximately 15,000 centipoise. In Table 1, it can be seen that good results are achieved with Cal85™ added at the following rates: (i) 26.8 kg of Cal85™ per 1,000 kg of biosolids cake (equivalent to approximately 99 kg of CaO per 1,000 kg of biosolids in the biosolids cake (dry basis)); (ii) 33.6 kg of Cal 85™ per 1,000 kg of biosolids cake (equivalent to approximately 124.2 kg of CaO per 1,000 kg of biosolids in the biosolids cake (dry basis)); and (iii) 40.4 kg of Cal 85™ per 1,000 kg of biosolids cake (equivalent to approximately 149 kg of CaO per 1,000 kg of biosolids in the biosolids cake (dry basis)), depending in part on the amount of process liquid added in each case. As noted in Table 1, in the samples utilized, the biosolids cake has a biosolids content of approximately 23% by weight of the biosolids cake.

As can be seen in Table 1, the lowest alkali addition rate (26.8 kg of Cal 85™ per 1,000 kg of biosolids cake, or 99 kg of CaO per 1,000 kg of biosolids in the biosolids cake) resulted in the fertilizer product having viscosity far less than 15,000 cP, in certain cases. Accordingly, based on Table 1, it is believed that approximately 75 kg of CaO per 1,000 kg of biosolids in the biosolids cake would result in a fertilizer product with an acceptably low viscosity (i.e., less than 15,000 cP). Similarly, based on Table 1, it is believed that approximately 150 kg of CaO per 1,000 kg of biosolids in the biosolids cake would result in a fertilizer product with an acceptably low viscosity.

The results in Table 1 also indicate that at least about 142 grams of process liquid preferably is included in the mixture, where 200 grams of biosolids cake (having 23% biosolids) is also included in the mixture. This is equivalent to approximately 3,087 kg of water per 1,000 kg of biosolids in the biosolids cake (dry basis). Accordingly, it is believed that at least approximately 3,080 kg of water per 1,000 kg of biosolids in the biosolids cake (dry basis) would result in the fertilizer product having an acceptably low viscosity (i.e., less than approximately 15,000 cP), where the biosolids cake has a biosolids content of approximately 23% by weight.

The amount of the process liquid required to be added depends, in part, on the proportion of biosolids in the biosolids cake. In general, the biosolids content of the biosolids cake may vary from between approximately 18% to approximately 26% by weight. For example, based on the results in Table 1, it is estimated that at least approximately 1,881 kg of process liquid would be required (per 1,000 kg of biosolids in the biosolids cake), where the biosolids cake has a biosolids content of 18%. Similarly, it is estimated that at least approximately 3,589 kg of process liquid would be required (per 1,000 kg of biosolids in the biosolids cake), where the biosolids cake has a biosolids content of 26%.

“Total solids” in Table 1 refers to both the biosolids in the fertilizer product, and the process alkali. As can be seen in Table 1, it appears that the viscosity of the fertilizer product is acceptable up to approximately 16% biosolids by weight of the fertilizer product, i.e., depending on various factors, e.g., rate of alkali addition, or storage time. As can be seen in Table 1, if total solids are considered, the corresponding figure is 17.5%, i.e., the maximum concentration of 17.5% by weight total solids in the fertilizer product may be acceptable.

In general, the particles of Cal85™ had diameters of at least about 0.5 mm, however, finer particles were also included.

### Experiment 2

In experiment 2, two higher Cal85™ dose rates (33.6 kg/metric ton of biosolids cake, and 40.4 kg/metric ton of biosolids cake) are processed with a narrower range of solids contents in the fertilizer product, being 12.18% to 14.26% biosolids by weight. The results are presented in Table 2.

Results show that a fertilizer product having 14.26% biosolids by weight can be prepared by this “cold” process (no added heat), with its viscosity over time ranging from 5200-8400 cP at a Cal85™ dose rate of 33.6 kg/metric ton of biosolids cake. Corresponding lower, 3500-4500 cP, viscosities for this product are produced at a Cal85™ dose rate of 40.4 kg/metric ton of biosolids cake.

TABLE 2
High Throughput/Cold Process for Production of Pumpable Biosolids Liquid
Effect of Cal85 dose rate and solids concentration on product viscosity and pH

| | | | | Biosolids | Viscosities | | | | | |
|---|---|---|---|---|---|---|---|---|---|---|
| Ingredients | | | | % by | (0-75 days) | | | pH (0-75 days) | | |
| Cake 23% | H2O | Cal85 | Total | Weight | 0 d | 1 d | 75 d | 0 d | 1 d | 75 d |
| 200 g | 132 g | 6.72 g | 16 | 14.26 | 5231 | 8400 | 5741 | 11 | 10.7 | 10.8 |
| | 149 g | (33.6 Kg/MT | 15 | 13.37 | 4247 | 4421 | 4637 | 11 | 10.3 | 10.6 |
| | 180 g | Cake) | 14 | 12.47 | 1728 | 2993 | 2897 | 11 | 10.5 | 10.5 |
| | 140 g | 8.8 g | 16 | 13.92 | 3665 | 4547 | 3413 | 11.9 | 10.9 | 11.4 |
| | 163 g | (40.4 Kg/MT | 15 | 13.05 | 1746 | 3191 | 2262 | 11.9 | 11.2 | 11.2 |
| | 190 g | Cake) | 14 | 12.18 | 1116 | 1884 | 1356 | 11.9 | 11.1 | 11.5 |

Cake + Cal85 was mixed in KitchenAid mixer for 2 minutes and then 200 g was dispensed into containers, water added and BD mixer for ~2 minutes. Gentle mixing keeps viscosity down and it stays down. Cells remain intact.

### Experiment 3

The impact of duration of mixing, and of added destructive shearing, was explored, and results are shown in Table 3.

In the experiments for which results are shown in Table 3, all process ingredients were added to a mixing vessel and stirred/mixed for two, five, and 10 minutes respectively, using a symmetrical stirring mixing augur. The two-minute mix exhibited a poorer viscosity (8,500 cP, measured immediately after mixing), compared to the five- and 10-minute mixes (5,600-5,900 cP). Viscosity patterns were similar in all the preparations during storage days 1 through 75, and ended up at 4,100-4,300 cP, a pumpable mixture.

TABLE 3
High Throughput/Cold Process for Production of Pumpable Biosolids Liquid
Effect of duration of mixing on product viscosity and pH

| | | | | Product | | | | | | | | | |
|---|---|---|---|---|---|---|---|---|---|---|---|---|---|
| | | | | Mixing | | | | | | | | | |
| | | | Solids | time | | | | | | | | | |
| Ingredients* | | | Content % | (min)* | | | | | | | | | |
| Cake | | | by Weight | Bio- | | | Viscosities (0-75 days) | | | | pHs (0-75 days) | | |
| 23% | H2O(g) | Cal85 | Total | solids | | Appearance | 0 d | 1 d | 7 d | 75 d | 0 d | 1 d | 7 d |
| 750 g | 559 | 25.2 g | .15 | 13.45 | 2 | A bit grainy | 8498 | 5567 | 5051 | 4307 | 10.9 | 11.6 | 11.4 |
| | | (33.6 Kg/MT | | | 5 | Pastelike | 5663 | 5723 | 5225 | 4361 | 11.5 | 11.6 | 11.6 |
| | | Cake) | | | 10 | Pastelike | 5921 | 5663 | 5033 | 4133 | 11.8 | 11.7 | 11.7 |

Cake + water + Cal85 were mixed in KitchenAid mixer (setting 4, symmetrical arm) for 2, 5 and 10 min and dispensed into containers.

### Experiment 4

In experiments for which results are shown in Table 4, 23% biosolids cake and Cal85™ first were mixed in a mixer (utilizing an asymmetrical mixing augur) for two minutes. The asymmetrical augur was then replaced with the symmetrical augur, water was added and the ingredients were mixed for 2, 5, 10 and 15 minutes.

In one comparison with the prior art, 15-minute mixed material was also added to a single serve shear unit and then destructively sheared for two minutes. In another, 250 g of biosolids cake, and water, were also weighed into the single serve shear unit, and then sheared (i.e., mechanically destroyed) for five minutes. The different mixing/shearing conditions comparing the results of the third experiment with the prior art shearing process are set out in the central columns of Table 4.

Lowest mixing time (two minutes) gave the lowest viscosity and no benefit was observed when mixing time was extended.

TABLE 4
High Throughput/Cold Process for Production of Biosolids Liquid
Effect of duration of mixing on product viscosity and pH

| | | | Product | | | | | | | | | | |
|---|---|---|---|---|---|---|---|---|---|---|---|---|---|
| | | | Solids | | | | | | | | | | |
| | | | Content % | | | | | | | | | | |
| Ingredients | | | by Weight | | Mixing | Shear | Viscosities | | | | | | |
| Cake | | | | Bio- | time | Time | (0-75 days) | pH (0-75 days) | | | | | |
| 23% | H2O (g) | Cal85 (g) | Total | solids | (min) | (min) | 0 d | 1 d | 7 d | 75 d | 0 d | 1 d | 75 d |
| 750 g | 559 | 25.2 g | 15 | 13.45 | 2 | 0 | 3107 | 3593 | 3833 | 4103 | 11.3 | 11.4 | 11.5 |
| | | (33.6 Kg/MT | | | 5 | 0 | 5213 | 5405 | 4997 | 4367 | 11.5 | 11.5 | 11.5 |
| | | Cake) | | | 10 | 0 | 5501 | 5525 | 4949 | 4199 | 11.7 | 11.6 | 11.6 |
| | | | | | 15 | 0 | 5333 | 5549 | 4300 | 4577 | 11.9 | 11.7 | 11.7 |
| | | | | | 15 | 2 | 3641 | 3515 | 3371 | 2447 | 12 | 11.7 | 11.7 |
| 250 g | 186 | 8.4 g | 15 | 13.45 | 0 | 5 | 4163 | 3773 | 3449 | 2939 | 11.9 | 11.6 | 11.5 |
| | | (33.6 Kg/MT | | | 0 | 5 | 4187 | 4055 | 3647 | 2975 | 11.9 | 11.5 | 11.5 |
| | | Cake) | | | | | | | | | | | |

### Experiment 5

A reduction in viscosity was observed in some embodiments with added shearing. In these examples, the shear unit tended to heat up the mixture, due to friction.

The conclusion, that only minimal mixing is required for the process of the invention as is shown in the results in Table 4 wherein the ingredients (10 litres) were simply passed through a small 1/12 horsepower recirculating centrifugal pump.

Those skilled in the art would appreciate that, when the biosolids cake is subjected to shearing, individual microbial cells therein are torn apart, and the cellular components in the cell are released. However, it is unclear at this time why shearing does not appear to be advantageous. In any event, the additional energy input required for shearing the biosolids cake does not appear to achieve results that would justify the additional energy input.

TABLE 5
Effect of duration of mixing on mixture viscosity
Mixer: *KitchenAid Planetary Mixer with
paddle/mixer attachment Setting 6 (180 rpm)

| Cake | Cal85 | | Estimated | | Mix Time | |
|---|---|---|---|---|---|---|
| Kg (%) | (g) | Water Kg | Solids % | Paddle | (sec) | Visc cP |
| 0.5 | 20 | 0.500 | 13.7 | Flat | 20 | 1590 |
| (24) | | | | beater | 30 | 1974 |
| | | | | | 40 | 2423 |
| | | | | | 50 | 2927 |
| | | | | | 60 | 3185 |
| 0.5 | 20 | 0.420 | 14.9 | Flat | 20 | 3593 |
| (24) | | | | beater | 30 | 3749 |
| | | | | | 40 | 4649 |
| | | | | | 50 | 5567 |
| | | | | | 60 | 5681 |
| 0.6 | 24 | 0.432 | 15.9 | Flat | 20 | 7978 |
| (24) | | | | beater | 30 | 10460 |
| | | | | | 40 | 18420 |
| | | | | | 50 | 23780 |
| | | | | | 60 | 27440 |

** Model KSM100PSWH

### Experiment 6

Further mixing tests were implemented using a mixing device with an increased mixing speed (setting 6, 180 rpm and shorter mixing times of 20-60 seconds) The results can be seen in Table 5). The biosolids cake, Cal85™ and water ingredients produced mixtures with total solids contents of 13.7%, 14.9%, and 15.9%. Pumpable mixtures including up to 14.9% total solids were prepared with mixing durations of 20-60 seconds.

The mixture, with a viscosity of approximately 3,500 cP, appeared to be well mixed with no lumps of solids therein. In this experiment, the mixing element is a flat beater element. At a mixing time of two minutes, this would correspond to productivity of 1.5 metric ton/hour with power usage of 1.3 kilowatt, i.e., approximately 1 kilowatt/metric ton of fertilizer product produced.

Based on the foregoing, it appears that the method of the invention provides a stable liquid biosolids fertilizer product, pumpable as an organic mostly liquid fertilizer, with a viscosity of preferably less than approximately 6,000 cP, or at least less than approximately 8,000 to approximately 10,000 cP, which is free of pathogens and other microorganisms and is preserved by process alkali for extended periods of storage. The process and the resulting product are preferably prepared by cold mixing (i.e., mixing at ambient temperature, with no added heat) of 40.4 kg of Cal85™ per metric ton of biosolids in the biosolids cake, biosolids cake (having a biosolids content of approximately 23%) and sufficient process liquid to achieve a final biosolids concentration of approximately 14% (16% total solids). The product and process may be augmented without loss of viscosity by free addition of a normally solid KCl component due to its known fertilizer characteristics.

### Effect of Small Process Scale Mixers and Tank Configurations on Process Throughput

TABLE 6
Tests of Qep High Speed Mixer w Low Torque Paddle on Production of Pumpable BS:
Tank: Ss BrewTech 17 Gal Conical Tank

| | Cake | Cal85 | Water | Estimated | | Effect of Mix | | Throughput |
|---|---|---|---|---|---|---|---|---|
| Mixer Type | Kg (%) | Kg | Kg | Solids % | Paddle | Time (min) | Visc cP | EquivMT/h |
| Single shaft | 25 (24) | 1 | 24 | 14 | Universal | 1 | 2372 | 3.0 |
| Qep Mortar | | | | | Low | 2 | 3353 | 1.5 |
| Mixer, 110 v | | | | | Torque | 3 | 3383 | 1.0 |
| 1300 W 700 rpm | | | | | | | | |

### Experiment 7

The capabilities of several small scale (50-200 Kg) mixers from the cement/mortar/concrete mixer sector are used in the process. A Vertical Qep Mortar Mixer (1300 W), installed in a 17 gallon conical tank, transformed biosolids cake and water and Cal85 components into a pumpable mixture. Ingredients (to produce 50 kg of the fertilizer product) were added to the tank and mixed up for three minutes with the Qep 1300 W single shaft vertical high speed mortar mixer, with a universal paddle. The effect of the mixer on production of pumpable biosolids liquid was investigated.

Mixing for one minute did not appear to be sufficient, because some lumpy cake material was still present after one minute. Mixing for two minutes adequately broke up lumps producing well mixed materials and viscosities in mid 3,000 cP (Table 6). (At two minutes, this corresponds to productivity of 1.5 metric tons of product per hour, with power usage of 1.3 kW, i.e. approximately 1 kW/metric ton of fertilizer product produced).

The amounts of materials mixed in a previous experiment to produce 50 kg of the fertilizer mixture (i.e., 25 kg biosolids cake, 1 kg of Cal85™, 24 kg of water, as shown in Table 6) was repeated with a double shaft 1600 W high speed vertical mixer (Table 7). This was first run at setting 3 (approximately 400 rpm). This resulted in insufficient turbulence and the machine was slow and less effective at breaking up the small cake lumps in the mixture.

The above process using a conical tank and double shaft mixer was repeated, with the mixer operated at a speed of 800 rpm. This speed increase resulted in very good mixing generating a well-mixed product even after 30 seconds corresponding to a productivity of 6 metric tons of the fertilizer product per hour.

The process was repeated with a smaller mass of ingredients (35 Kg, rather than 50 Kg), the same equipment configuration (a 17 gallon conical tank, a double shaft 1600 W high speed mixer, run at 800 rpm, to provide better mixing. It is believed that, with short holding times, the Cal85™ may not have sufficient time to solubilize in the mix. When the process was repeated with Cal85™ having a finer particle size, mixing was even more efficient and the mixing time of 10 seconds was sufficient to produce a well-mixed product corresponding to a productivity of 12.6 metric tons of fertilizer mixture per hour. It is estimated that the finer particles of Cal85™ had diameters less than about 0.1 mm (less than 100 microns).

TABLE 7
Tests of Dual High Speed Mixer w Low Torque Paddle on Production of Pumpable BS
Tank: Tank: Ss Brew Tech 17 Gal Conical Tank

| | Cake | | | | | | | |
|---|---|---|---|---|---|---|---|---|
| | Kg | Ca185 | Water | | | Mix Time | Visc | Throughput |
| Mixer Type | (%) | Kg | Kg | EstSolids % | Paddle | sec | cP | EquivMT/h |
| Double shaft high | 25 (24) | 1.0 | 24 | 14 | Universal | 2 min small | 1900 | 1.5 |
| speed Mixer, 110 v, | | | | | Low | residual | | |
| 1600 W, Setting 11-3 | | | | | Torque | lumps | | |
| 400 rpm | | | | | | 3 min V | 2300 | 1.0 |
| | | | | | | small | | |
| | | | | | | residual | | |
| Double shaft | 24 (24) | | 24 | 13 | Universal | 10 | 1146 | 18 |
| high speed | | | | | Low | 20 | 2082 | 9 |
| Mixer, 110 v | | | | | Torque | 30 | 2519 | 6 |
| 1600 W | | | | | | 40 | 2891 | 4.5 |
| Setting 11-6- | | | | | | 50 | 3407 | 3.6 |
| 800 rpm | | | | | | 60 | 3407 | • |
| | 17.5 (24) | 0.7 | 17.5 | 13 | Universal | 10 | 1416 | 12.6 |
| | | | | | Low | 15 | 1908 | 8.4 |
| | | | | | Torque | 20 | 2000 | 6.3 |
| | | | | | | 25 | 2693 | 5 |
| | | | | | | 30 | 2933 | 4.2 |
| | | | | | | 35 | 3245 | 3.6 |
| | 17.5 (24) | 0.7 | 17.5 | 13.7 | Universal | 10 | 1794 | 12.6 |
| | | Fine | | — | Low | 15 | 2016 | 8.4 |
| | | | | | Torque | | | |

### Experiment 8

Different tank dimensions were tested, and the results demonstrate performance productivity of the double shaft 1600 W high speed mixer set at 800 rpm. In a 121 Litre PolyDrum Tank optimum productivity was observed with 85 Kg mixture productivity at 10 and 15 seconds, corresponding to 30 metric tons of mixture per hour, and 22.5 metric tons of mixture per hour respectively (Table 8).

TABLE 8
Tests of Dual High Speed Mixer w Low Torque Paddle on Production of Pumpable BS
Tank: 120 L PolyDrum (18″ Diam)

| | Cake | | Water | | | Mix Time | | Throughput |
|---|---|---|---|---|---|---|---|---|
| Mixer Type | kg | Ca185 kg | kg | TS % | Paddle | sec | Visc cP | Equiv MT/h |
| Double shaft high speed | 41.6 | 1.66 | 41.6 | 13.7 | Universal | 10 | 1884 | 30 |
| Mixer, 110 v; 1600 w | | | | | Low | 15 | 1878 | 22.5 |
| Setting II-6- | | | | | Torque | | | |
| 800 rpm | | | | | | | | |
| Liquid HT 20″. Shaft | | | | | | | | |
| centred on cylinder | | | | | | | | |
| Impellar. | | | | | | | | |
| Diam7.5″MT7.5″ | | | | | | | | |
| Shafts: 3.25″ apart | | | | | | | | |

### Experiment 9

The contents in the Polydrum represented a cylinder of diameter 18 inches, height 20 inches. The twin shafts were 3.75 inch centers apart and the twin impellers had a height of 7.5 inches, combined width of 7.5 inches. Impellers were centered in the cylinder. These principal parameters for optimal processing are summarized in Table 9 for the above mentioned 121 L PolyDrum and for a 55 gallon drum.

TABLE 9
High throughput batch process for production of pumpable biosolids

| | | |
|---|---|---|
| Tank Size | 120 L | 55 Gal |
| Weight of contents (Kg) | 85 | 150 |
| Tank Diameter in inches | 18 | 23.3 |
| (-optimal for mixer) | | |
| Approx Height of Liquid in Tank | 20 | 23.3 |
| (-optimal for mixer) | | |

| | |
|---|---|
| High Speed Mixer | Vertical, double shaft |
| Mixer Power | 110 V, 1600 W |
| Mixer Setting | 11, 6 |
| Mixer estimated rpm | 800 |
| Combined Paddle Width/ | 7.5 |
| Diameter in inches | |
| Paddle Height | 7.5 |
| Location of Mixer | Positioned Vertically |
| Location of Paddles | Centred within Liquid Cylinder |
| | Column |
| Composition of ingredients | 24% Cake; Cal85 40 g/Kg Cake; |
| | Water to achieve 13.7-15% solids |
| Mixing Time (sec) | 10 |
| Product Viscosity (cP) | <6000 |

### Supplementary Process Variations to Meet Jurisdictional Requirements

### Experiment 10

While the high pH of the treatment processes described above eliminates microbial pathogens and produces a fertilizer product which is microbially stable in storage, it may fall short of satisfying some biosolids quality/jurisdictional requirements/regulations with respect to Helminth ova. At pH-12 these regulations may require, for example, a five-minute hold at 58° C., or a two-hour hold at 52° C., to insure total ova destruction. Accordingly, in one embodiment, the mixture is held at a preselected temperature for a preselected time period, according to regulations. Those skilled in the art would appreciate that the throughput of this embodiment of the method of the invention would be lower than the throughput of the other embodiments described herein.

The effect of minimal energy inputs to achieve the temperatures for Helminth ova kill (e.g., two hours at 52° C., and five minutes at 58° C.) on product viscosity are presented in Table 10. In addition, the impact of thermally treating the biosolids before and after water addition is shown.

Where heat is required to achieve Helminth ova kill, a hot water tank to supply water at 80° C. or 90° C. preferably is added to the tank and mixer assembly to achieve a final mixture temperature of 53.5° C. or 60° C. as per guidance from Table 10 (1a, b-4). Because of the increased temperature of the mix and the lower apparent viscosity of the hot mix the double shaft high speed mixer effectively mixes a greater volume of material in 10 seconds. (The contents represent a cylinder of diameter 23 inches and height 23 inches in a standard 55 gallon drum.) This constitutes a productivity of up to 150 kg of the mixture per 10 seconds, corresponding to a productivity of greater than 50 metric tons of the mixture per hour.

TABLE 10
Effect of temp holds for Helminth KIII (2 h/52 C.; 5 min/58 C.) on product
viscosity (and impact of treating biosolids before or after water addition)
Temp hold is on final diluted product le Cake + Lime + Hot Water

| | | | Temp C. | | | | | | | | |
|---|---|---|---|---|---|---|---|---|---|---|---|
| | | | after | | | | | | | | |
| | | | addition | Cake/ | | | | | | | Visc |
| | | | of Cal85* | Lime | | Water | | | | | Aft |
| | | Cake | 40 g/Kg | Amount | Water | Amount | Combined | | | Hold Time/ | process |
| | | Temp C. | Cake | Kg | Temp C. | Kg | Temp C. | Solids Conc % | Mixing | Temp (C.) | cP |
| 24% | 1a | 25 | +10 = 35 | 1 | 90 | 0.9 | 60.3 | 14.7 | Flat beater | 2 h/52 | 2885 |
| Cake | 2 | 25 | +10 = 35 | 1 | 80 | 0.7 | 53.5 | 16.5 | beater | 2 h/52 | 4787 |
| | 3 | 25 | +10 = 35 | 1 | 80 | 0.6 | 51.8 | 17.5 | Kitchenaid | 2 h/52 | 17460 |
| | 4 | 25 | +10 = 35 | 1 | 90 | 0.5 | 53.3 | 18.6 | Augur | 2 h/52 | 47040 |
| | 1b | 25 | +10 = 35 | 1 | 90 | 0.9 | 60.3 | 14.7 | 20 sec | 5 min/58 | 2507 |
| | | | | | | | | | setting 6 | | |

Temp hold is on Cake + Lime with cold water added after hold

| | | | Temp after | | | | | | | |
|---|---|---|---|---|---|---|---|---|---|---|
| | | | addition of | Cake/ | | | Cold | | | Visc |
| | | | Ca185 | Lime | | Hold | Water | | | Aft |
| | | Cake | 40 g/Kg | Amount | | Time/ | Amount | Solids | | process |
| | | Temp C. | Cake | Kg | Mix | Temp C. | Kg | Conc % | Mixing | cP |
| 24% | 5a | 25 | +10 = 35 | 1 | Hook C | 2 h/52 | 0.9 | 14.7 | Flat beater | 1830 |
| Cake | 6 | 25 | +10 = 35 | 1 | Shape | 2 h/52 | 0.7 | 16.5 | Kitchenaid | 3569 |
| | 7 | 25 | +10 = 35 | 1 | KitchenAid | 2 h/52 | 0.6 | 17.5 | Augur | 5633 |
| | 8 | 25 | +10 = 35 | 1 | Augur | 2 h/52 | 0.5 | 18.6 | 20 sec | 28280 |
| | 5b | 25 | +10 = 35 | 1 | 20 sec | 5 min/58 | 0.9 | 14.7 | setting 6 | 2507 |
| | | | | | setting 6 | | | | | |

“Addition of Cal85 ™ increases the temperature of the cake-lime mix

With these results, a heat treatment of 52° C. for two hours of the cake and lime mixture (i.e., with cold water added afterwards) or the cake and lime and water mixture produces pumpable product (i.e., having viscosity of approximately 6,000 cP, or less) containing up to 16.5% total solids, including the optional KCl component. In Table 10, lines 1a,b and 5a,b show similar (slightly lower) viscosities were achieved with a thermal hold of five minutes at 58° C. Comparison of set 1-4 in Table 10 (thermal cake-lime-water treatment), with set 5-8 (thermal cake-lime treatment, water added afterwards) shows lower viscosities were consistently achieved in set 1-4.

From an energy input perspective, however, thermal treatment of set 5-8 is more economical because only the cake and lime mix, and not the water component, is heated. It should be noted that the mixing in (i.e., hydration) of the lime contributes to the heating process. It is believed that mixing in the lime adds approximately 10° C. to the temperature of the biosolids cake, and approximately 5° C. to heating the diluted cake mix.

The treatment of the samples in set 1-4 is less complex because it requires one mixing step (i.e., all ingredients in) whereas the set 5-8 treatment requires two mixing steps, the first for cake and lime, the second to dilute the thermally treated cake and lime mixture. In addition a thermal hold between the two mixing steps complicates a continuous process more than would a single-mix-all-ingredients-in approach. Holding for five minutes at 58° C. is easily accommodated in a continuous process. However, a two-hour hold at 52° C. can be accommodated in a high throughput process provided the product is allowed to ‘condition’ at approximately 52° C. for two hours.

To meet specific Class A EPA503 requirements, dewatered biosolids cake delivered from centrifuge or filter press is pre-batch-heated at 70° C., for 30 minutes prior to the lime-water mixing step. Sufficient alkali is added to maintain EPA vector attraction requirements for exceptional quality, i.e., pH 12 or more for at least two hours, then pH11.5 or more for another 22 hours.

### Further Embodiments

In a further embodiment, the lime as the operative alkali is replaced with an equivalent amount of an alternative alkali, such as potassium, sodium, ammonium hydroxide or the hydroxides of the alkali metals and of ammonium, that neutralize acids to form salts with a pH of greater or preferably much greater than 7.

In a still further embodiment the ingredients are added and intermixed in a serial staggered fashion by deferral of incorporation of one or more of the components and steps.

Those skilled in the art would appreciate that, except where specifically otherwise stated above, the order in which the components of the fertilizer mixture are added into a mixing vessel to be mixed together, to provide a mixture to form the fertilizer product of the invention, is not important.

Those skilled in the art would appreciate that the method of the invention may be utilized in batch or continuous processes. The method of the invention has a number of advantages, and in particular the method is suitable for use in rural areas or in areas where sources of funding for processing biosolids are extremely limited. Some of the advantages are as follows:

(a) No heating costs (capital or operating);

(b) Reduced mixing costs, no energy input for shearing;

(c) Small footprint (lower capital costs, and lower operating costs);

(d) High production throughput rates, only limited by mixing/pumping rates;

(e) Suitable for use with more dilute biosolids or semi-solid biosolids (e.g., manures);

(f) Suitable for mounting on a mobile platform.

As noted above, the system in which the method of the invention is implemented may be mounted on a mobile platform. For example, in one embodiment, the system may include a recirculating mixing pump installed to recirculate the mixture in a mobile tanker unit used to transport the fertilizer mixture from the facility at which the biosolids cake is generated to the location at which the fertilizer product is to be spread, e.g., on fields. That is, the mixing of the mixture according to the method of the invention may be performed in the tanker as it travels from the biosolids generating facility to the ultimate destination of the fertilizer product of the invention.

As noted above, the method of the invention kills pathogens and other micro-organisms. The fertilizer product of the invention appears to maintain good viscosity, pH, and microbial count, while stored for relatively long periods.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

I claim:

1. A method of forming a fertilizer product having a preselected viscosity, the method comprising:
(a) forming a mixture comprising:
(i) a biosolids cake comprising biosolids defining a biosolids content thereof;
(ii) alkali in a predetermined amount based on the biosolids content of the biosolids cake;
(iii) sufficient process liquid to result in the fertilizer product having a product biosolids content up to approximately 16% by weight of the fertilizer product; and
(b) with a mixing element, mixing the mixture comprising the biosolids cake, the alkali, and the process liquid for a predetermined time period, the mixing element rotating at a predetermined tip speed during the predetermined time period, to produce the fertilizer product.

2. The method according to claim 1 in which the biosolids content is between approximately 18% and approximately 26% by weight of the biosolids cake.

3. The method according to claim 1 in which the predetermined tip speed is less than approximately 1,000 feet per minute.

4. The method according to claim 1 in which the preselected viscosity is less than approximately 15,000 centipoise.

5. The method according to claim 4 in which the preselected viscosity is approximately 6,000 centipoise or less.

6. The method according to claim 1 in which the process liquid is water.

7. The method according to claim 1 in which the process liquid is a dilute liquid biosolids feed.

8. The method according to claim 1 in which the fertilizer mixture comprises at least 14% biosolids by weight of the mixture.

9. The method according to claim 1 in which the biosolids cake is at least partially prepared from anaerobically digested biosolids.

10. The method according to claim 1 in which the predetermined amount of the alkali is at least approximately 75 kilograms of CaO per 1,000 kilograms of the biosolids in the biosolids cake.

11. The method according to claim 1 in which the predetermined amount of the alkali is up to approximately 150 kilograms of CaO per 1,000 kilograms of the biosolids in the biosolids cake.

12. The method according to claim 1 in which the alkali is selected from the group consisting of finely granulated lime, hydrated solid lime, slaked lime, finely granulated solid sodium hydroxide, finely granulated solid potassium hydroxide, liquid sodium hydroxide, liquid potassium hydroxide, and combinations thereof.

13. The method according to claim 1 in which the predetermined tip speed is between approximately 250 feet per minute and approximately 1,000 feet per minute.

14. The method according to claim 1 in which the biosolids cake, the alkali, and the process liquid are mixed together without shearing microbial cells in the biosolids of the biosolids cake.

15. The method according to claim 1 in which the predetermined time period is between approximately 5 seconds and approximately 60 seconds.

16. The method according to claim 1 in which the mixing of the biosolids cake, the alkali, and the process liquid is effected with an energy input of between 0.05 kWh and 0.5 kWh per 1,000 kilograms of the fertilizer product produced.

17. The method according to claim 1 additionally comprising the step of:
(c) storing the fertilizer product for a preselected time period.

18. The method according to claim 17 in which the preselected time period is between approximately one day and approximately 75 days.

19. The method according to claim 1 additionally comprising the step of heating the fertilizer mixture to a preselected temperature for a preselected heating time period to kill Helminth ova in the fertilizer mixture to a preselected extent.
